(19) United States
(12) Patent Application Publication
(10) Pub. No.: US 2013/0268366 A1
(43) Pub. Date: Oct. 10, 2013

(54) MESSAGING SYSTEM AND METHOD THEREOF

(71) Applicant: HICCAPP TECHNOLOGIES LTD., Netanya (IL)

(72) Inventors: Noam Gordon, Netanya (IL); Boaz Gordon, Netanya (IL)

(73) Assignee: Hiccapp Technologies Ltd., Netanya (IL)

(21) Appl. No.: 13/858,573

(22) Filed: Apr. 8, 2013

Related U.S. Application Data
(60) Provisional application No. 61/622,042, filed on Apr. 10, 2012.

(51) Int. Cl. G06Q 30/02

(52) U.S. Cl. CPC G06Q 30/0262
USPC 705/14.59; 455/466

(57) ABSTRACT

A messaging method includes a step of waiting for receiving content to be displayed on the screen of a receiving device, upon receiving a content, checking whether one or more criteria and/or conditions are met while the receiving device is in an idle mode, and whenever one or more criteria/condition are met, displaying the received content.

### FIELD OF THE INVENTION

The present invention relates to the field of electronic messaging systems. More particularly, the invention relates to a method for displaying content in form of messages or other displayable information while the receiving device (e.g., a cellular phone, a smart-phone or other portable computer based communication device) is in idle mode, while allowing the sender to receive a feedback whenever the user of the receiving device noticed the displayed message.

### BACKGROUND OF THE INVENTION

As more users are equipped with mobile communication devices (i.e., a receiving device) such as smart-phones, it is sometimes desired by a sending entity (e.g., a person or an advertiser) to send content (e.g., text messages, commercial offers or coupons, visual content such as photos, etc.) to a receiving device in order to display that content at the receiving device such that it will be noticeable by the end user of the receiving device. In some cases, the sender wishes to know whether the end user have noticed the displayed content (or at least, in some manner, pay attention to it). However, there are cases where the receiving device is in an idle mode or standby (while the incoming content is displayed) so that the sender is unable to receive any indication that the end-user has actually viewed the content sent by the sender at about the time of receiving it at the receiving device (i.e., in real-time). Moreover, in such cases the sender may even wish not to send any content to the receiving device of the end user.

It is object of the present invention to provide a system which is capable of permitting a sending entity to send content to a receiving device in order to make that content pop-up on the display of the receiving device, while the receiving device is in idle mode or standby, in particularly, only when the system “knows” that the end user will be able to notice that message in real-time.

It is another object of the present invention to provide a system which is capable of permitting a sending entity to receive automatic feedback responses from the receiving device, whenever the end user have notice the displayed content (or at least, in some manner, pay attention to it).

Other objects and advantages of the invention will become apparent as the description proceeds.

### SUMMARY OF THE INVENTION

The present invention relates to a method for displaying content in a receiving device (e.g., a smart-phone) while said receiving device is in an idle mode, comprising the step of:

a) waiting for receiving a content to be displayed on the screen of the receiving device;

b) upon receiving a content, checking whether one or more criteria and/or conditions are met while the receiving device is in the idle mode; and

c) whenever one or more criteria/condition are met, displaying said received content.

According to an embodiment of the present invention, the method further comprises the step of:

a) upon displaying a received content, monitoring whether positive viewage condition occurred;

b) upon identifying such positive viewage condition, generating positive viewage indication; and

c) sending said positive viewage indication to a remote server.

According to an embodiment of the present invention, the method further comprises:

a) receiving a request from a first end-user to view contents in a receiving device associated with the first end-user;

b) determining whether said first end-user satisfies at least one consumer targeting parameter;

c) upon determining that the first user satisfies at least one consumer targeting parameter, associating a unique identifier with said first end-user, and serving said identifier associated therewith to said receiving device; and

d) when said receiving device is in idle mode, waiting for receiving and displaying contents by using a monitoring algorithm of an application running on said receiving device.

### BRIEF DESCRIPTION OF THE DRAWINGS

In the drawing:

FIG. 1 schematically illustrates an exemplary operating environment for implementing embodiments of the present invention.

### DETAILED DESCRIPTION OF THE INVENTION

The subject matter of the present invention is described with specificity herein to meet statutory requirements. However, the description itself is not intended to limit the scope of this invention. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the terms should not be interpreted as implying any particular order among or between various steps herein disclosed unless and except when the order of individual steps is explicitly described.

### Definitions

The term “content” refers herein to any form of electronic message, such as visual message, audio message, textual message or a combination thereof.

The terms “sending entity” or “the sender” refers herein to any party (commercial or private) which uses the system of the present invention in order to distribute content.

The term “receiving device” refers herein to any computer based portable communication device capable of displaying content on the entire area of its screen or at least on part of it, and contains tactical sensor(s) to indicate a movement of the receiving device (e.g., motion sensor/accelerometer, ambient light/optical sensor, gyroscope, micromachined accelerometer, or any other suitable elements capable of detecting the position of the receiving device and/or its surroundings). The indication of the movement is used to provide an automatic feedback (i.e., a positive viewage) while noticing (or paying attention to) the content, by changing the orientation of the receiving device during the time while the content is displayed (e.g., 5-10 seconds).

The term “End-User” refers herein to the holder of the receiving device on which the content is displayed.

The term “Positive Viewage” refers herein to an indication that an end-user has viewed the content sent by the sender on his (the end-user) receiving device.

The term “Positive Viewage Condition” refers herein to a rotation or tilt of the receiving device in any direction of 3-D space while displaying the content. The positive viewage indication is generated according to the sensed positive viewage condition, by an application (i.e., a software code) executed/running on the receiving device.

Embodiments of the present invention are generally directed to permitting a sending entity (e.g., a person or an advertiser) to send content (e.g., text messages, commercial offers or coupons, etc.) to a receiving device in order to display that content while the receiving device is in idle mode or standby. Further, embodiments of the present invention are directed to permitting the sending entity (a person or entity associated with an advertiser) to receive automatic feedback responses from the receiving device, whenever the end user have notice the displayed content (or at least, in some manner, pay attention to it according to the sensed positive viewage condition).

The present invention relates to a messaging system that provides the sender the ability to know that a positive viewage has occurred. The sender submits the content and presets conditions which determine to whom, when and where it will be sent. These conditions may include demographic data, phone number, physical location, hobbies and interests, time of day, etc.

After the sender submits the content, it will be transferred to a remote server which will then distribute the content to those end-users that meet the conditions. During the time that the content is being displayed on the receiving device, the application will continuously monitor whether positive viewage condition has been met. Once the positive viewage condition has been met, the application will note the relevant information for this positive viewage (which content was displayed, when, to whom, etc). This information may be stored locally on the receiving device for later transfer to a server (e.g., the remote server), or may be transferred immediately to the server, without local storage. This information will be then sent back to the remote server and will be accessible to the sender.

According to an embodiment of the invention, the decision to display the content to specific end-users at certain times is made solely by the application, according to the conditions preset by the sender coupled with the criteria for minimum false positives (see examples below). No intervention by the end-user is required. In order to minimize, false positives towards a statistical zero, certain criteria must be met before the application decides to display the content and activate its monitoring algorithm.

These criteria may be:

Proper lighting—The receiving device must be exposed to a level of light greater than a predetermined threshold. For instance, when the receiving device is placed in a relatively poor lighting surroundings (e.g., inside a suitcase or a bag), no content will be displayed. For example, this can be done by any suitable sensor embedded within the receiving device (e.g., an optical sensor or other light sensitive sensor).

Idle time—The receiving device must be in standby mode and physically idle within a certain time span which will be predetermined.

Accordingly, in one aspect, an embodiment of the present invention is directed to one or more computer-readable storage media storing computer-useable instructions that, when used by one or more receiving devices, causes the one or more receiving devices to perform a method for indication of content positive viewage. The method involves the steps of: a) receiving a request from a first end-user to view contents (e.g., an electronic coupon); b) determining whether the first end-user satisfies at least one consumer targeting parameter. Upon determining that the first user satisfies at least one consumer targeting parameter, the method further includes: c) associating a unique identifier with the first end-user, and serving the identifier associated therewith to a receiving device associated with the first end-user; d) when the receiving device is in idle mode, waiting for receiving and displaying contents by using a monitoring algorithm of an application suitable to be executed by the receiving device; e) upon displaying a received content, monitoring whether positive viewage condition occurred; f) upon identifying such positive viewage condition, generating positive viewage indication; and g) sending said positive viewage indication to a remote server.

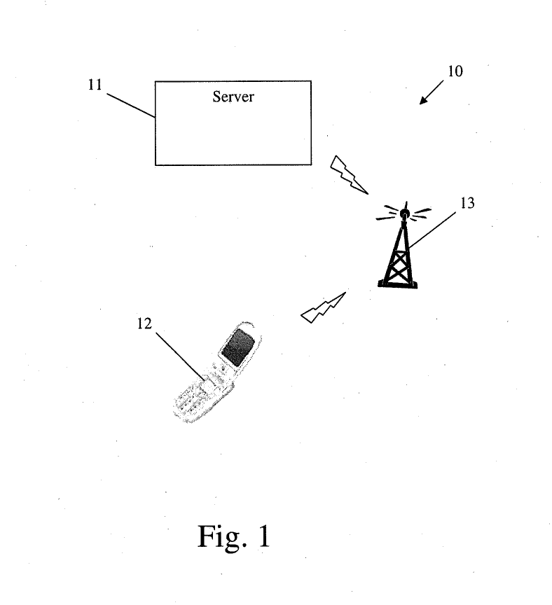

Having briefly described an overview of embodiments of the present invention, an exemplary operating environment in which embodiments of the present invention may be implemented is described below in order to provide a general context for various aspects of the present invention. Referring to FIG. 1, an exemplary operating environment for implementing embodiments of the present invention is shown and designated generally as computing system 10. The computing system 10 is but one example of a suitable computing environment and is not intended to suggest any limitation as to the scope of use or functionality of the invention. Neither should the computing system 10 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a smart-phone or other receiving device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing system 10 comprises a server 11 and at least one receiving device 12. The server 11 directly or indirectly couples elements such as: a memory, one or more processors, input/output ports, input/output components, and an illustrative power supply. The inventors hereof recognize that such is the nature of the art, and reiterate that the diagram of FIG. 1 is merely illustrative of an exemplary computing system that can be used in connection with one or more embodiments of the present invention. Distinction is not made between such categories as “workstation,” “server,” “laptop,” “hand-held device,” etc., as all are contemplated within the scope of FIG. 1 and reference to “computing system.”

The figure depicts embodiments of the present invention for purposes of illustration only. One skilled in the art will readily recognize from the following description that alternative embodiments of the structures and methods illustrated herein may be employed without departing from the principles of the invention described herein.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Similarly, while certain examples may refer to a cellular telephone, other computer or electronic systems can be used as well, such as, without limitation, network-enabled personal digital assistant (PDA), a network game console, a networked entertainment device, a smart-phone (e.g., with an operating system and on which a user can install applications) and so on.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A messaging method, comprising the step of:
a) waiting for receiving content to be displayed on the screen of a receiving device;
b) upon receiving a content, checking whether one or more criteria and/or conditions are met while the receiving device is in an idle mode; and
c) whenever one or more criteria/condition are met, displaying said received content.

2. A method according to claim 1, further comprising the step of:
a) upon displaying a received content, monitoring whether positive viewage condition occurred;
b) upon identifying such positive viewage condition, generating positive viewage indication; and
c) sending said positive viewage indication to a remote server.

3. A method according to claim 1, further comprising:
a) receiving a request from a first end-user to view contents in a receiving device associated with the first end-user;
b) determining whether said first end-user satisfies at least one consumer targeting parameter;
c) upon determining that the first user satisfies at least one consumer targeting parameter, associating a unique identifier with said first end-user, and serving said identifier associated therewith to said receiving device; and
d) when said receiving device is in idle mode, waiting for receiving and displaying contents by using a monitoring algorithm of an application running on said receiving device.
